(19) United States
(12) Patent Application Publication
(10) Pub. No.: US 2006/0276156 A1
(43) Pub. Date: Dec. 7, 2006

(54) Filter coefficient generating device, filter, multipath simulator and filter coefficient generating method, program, and recording medium

(75) Inventors: Juichi Nakada, Gunma (JP); Satoshi Utsumi, Satoshi (JP)

Correspondence Address: GREENBLUM & BERNSTEIN, P.L.C., 1950 ROLAND CLARKE PLACE, RESTON, VA, 20191, US

(73) Assignee: Advantest Corporation, Tokyo (JP)

(21) Appl. No.: 11/181,871

(22) Filed: Jul. 15, 2005

(30) Foreign Application Priority Data
May 17, 2005 (JP) 2005-144314

(51) Int. Cl. H04B 1/06; H04B 1/10

(52) U.S. Cl. 455/307

(57) ABSTRACT

A multipath simulation is simply carried out. There is provided an FIR filter 16 that receives a digital I signal (Q signal), and outputs a digital I′ signal (Q′ signal), a filter coefficient generating section 14 that generates a filter coefficient used in the FIR filter 16 based upon a sampling frequency fₛₐₘₚ, an RF modulation angular frequency ω, a path delay period τₘ, and a size of a path βₘ, an I′ signal D/A converter 22I (Q′ signal D/A converter 22Q) that converts the digital I′ signal (digital Q′ signal) into an analog I′ signal (analog Q′ signal) at a sampling frequency fₛₐₘₚ, an I′ signal multiplier 28I that multiplies the analog I′ signal by an RF signal with the RF modulation angular frequency ω, a Q′ signal multiplier 28Q that multiplies the analog Q′ signal by an orthogonal RF signal with the same frequency as the RF signal, and orthogonal in phase to the RF signal, and an adder 32 that adds an output from the I′ signal multiplier 28I to an output from the Q′ signal multiplier.

### BACKGROUND ART

1. Technical Field of the Invention

The present invention relates to a simulation of a multipath.

2. Related Art

There has been recognized a phenomenon where a signal transmitted to a receiver reaches the receiver after routing through multiple paths. This type of phenomena is referred to as multipath, and there is a proposed simulation method of the multipath (refer to Patent Document 1, for example).

As the simulation method of the multipath, for example, there is a method which uses an analog circuit provided with delay circuits and attenuators corresponding to the number of paths of a multipath (refer to FIG. 5 of Patent Document 1, for example). However, according to this method which employs the analog circuit, if the number of the paths of the multipath increases, the scale of the circuit becomes excessively large. To address this problem, there is a proposed method which replaces the analog circuit with a digital circuit (refer to FIG. 1 of Patent Document 1, for example).

(Patent Document 1) Japanese Laid-Open Patent Publication (Kokai) No. H4-351024

### SUMMARY OF THE INVENTION

However, even if an analog circuit is replaced by a digital circuit, it is still necessary to set delay periods and the like according to the number of paths of a multipath. Consequently, the simulation of the multipath becomes complex. Moreover, there are 300 to 7000 of paths for a model used to evaluate a UWB (Ultra Wide Band) system, and a simulation of the multipath thereof becomes more complex.

An object of the present invention is to easily carry out a simulation of a multipath.

According to the present invention, a filter coefficient generating device includes: an impulse response generating unit that, based upon path delay periods of respective paths and a sampling frequency of a digital I signal and a digital Q signal, generates a discrete impulse response based upon the sampling frequency for a digital filter realizing the path delay periods; a path ratio multiplying unit that multiplies the impulse response by a path ratio; a phase rotating unit that reversely rotates a phase of an output from the path ratio multiplying unit by (RF modulation angular frequency)×(path delay period); a real part accumulating unit that accumulates a real part of an output from the phase rotating unit; and an imaginary part accumulating unit that accumulates an imaginary part of the output from the phase rotating unit, wherein: it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).

According to the thus constructed filter coefficient generating device, an impulse response generating unit, based upon path delay periods of respective paths and a sampling frequency of a digital I signal and a digital Q signal, generates a discrete impulse response based upon the sampling frequency for a digital filter realizing the path delay periods. A path ratio multiplying unit multiplies the impulse response by a path ratio. A phase rotating unit reversely rotates a phase of an output from the path ratio multiplying unit by (RF modulation angular frequency)×(path delay period). A real part accumulating unit accumulates a real part of an output from the phase rotating unit. An imaginary part accumulating unit accumulates an imaginary part of the output from the phase rotating unit. Furthermore, it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).

According to the filter coefficient generating device of the present invention, the digital filter may be a Nyquist filter.

According to the filter coefficient generating device of the present invention, the path delay period may be a remainder obtained by dividing a time difference between a period required for the RF modulated signal to pass a path and a period required for the RF modulated signal to pass another path by a sampling period which is a reciprocal of the sampling frequency.

According to the filter coefficient generating device of the present invention, the real part accumulating unit and the imaginary part accumulating unit may change a subject to be accumulated according to the maximum integer number equal to or smaller than a value obtained by dividing the time difference by the sampling period.

According to the present invention, a filter includes: an I signal delaying unit that delays a digital I signal by a sampling period of the digital I signal; a Q signal delaying unit that delays a digital Q signal by a sampling period of the digital Q signal; an I signal real part multiplying unit that multiplies an output from the I signal delaying unit by a predetermined real part coefficient, and outputs a multiplied result; an I signal imaginary part multiplying unit that multiplies the output from the I signal delaying unit by a predetermined imaginary part coefficient, and outputs a multiplied result; a Q signal real part multiplying unit that multiplies an output from the Q signal delaying unit by the predetermined real part coefficient, and outputs a multiplied result; a Q signal imaginary part multiplying unit that multiplies the output from the Q signal delaying unit by the predetermined imaginary part coefficient, and outputs a multiplied result; an I′ signal summing unit that subtracts a summation of the outputs supplied from the Q signal imaginary part multiplying unit from a summation of the outputs supplied from the I signal real part multiplying unit; and a Q′ signal summing unit that adds a summation of the outputs supplied from the I signal imaginary part multiplying unit to a summation of the outputs supplied from the Q signal real part multiplying unit, wherein: the predetermined real part coefficient is an output from said real part accumulating unit of the filter coefficient generating device; and the predetermined imaginary part coefficient is an output from the imaginary part accumulating unit of the filter coefficient generating device.

According to the thus constructed filter, an I signal delaying unit delays a digital I signal by a sampling period of the digital I signal. A Q signal delaying unit delays a digital Q signal by a sampling period of the digital Q signal. An I signal real part multiplying unit multiplies an output from the I signal delaying unit by a predetermined real part coefficient, and outputs a multiplied result. An I signal imaginary part multiplying unit multiplies the output from the I signal delaying unit by a predetermined imaginary part coefficient, and outputs a multiplied result. A Q signal real part multiplying unit multiplies an output from the Q signal delaying unit by the predetermined real part coefficient, and outputs a multiplied result. A Q signal imaginary part multiplying unit multiplies the output from the Q signal delaying unit by the predetermined imaginary part coefficient, and outputs a multiplied result. An I′ signal summing unit subtracts a summation of the outputs supplied from the Q signal imaginary part multiplying unit from a summation of the outputs supplied from the I signal real part multiplying unit. A Q′ signal summing unit adds a summation of the outputs supplied from the I signal imaginary part multiplying unit to a summation of the outputs supplied from the Q signal real part multiplying unit. Furthermore, the predetermined real part coefficient is an output from the real part accumulating unit of the filter coefficient generating device; and the predetermined imaginary part coefficient is an output from the imaginary part accumulating unit of the filter coefficient generating device.

According to the present invention, a multipath simulator includes: the filter coefficient generating device; the filter; an I′ signal D/A converter that converts the output from the I′ signal summing unit of the filter into an analog I′ signal at the sampling frequency; a Q′ signal D/A converter that converts the output from the Q′ signal summing unit of the filter into an analog Q′ signal at the sampling frequency; an I′ signal multiplier that multiplies the analog I′ signal by an RF signal with the RF modulation angular frequency; a Q′ signal multiplier that multiplies the analog Q′ signal by an orthogonal RF signal with the same frequency as the RF signal and orthogonal in phase to the RF signal; and an adder that adds an output from the I′ signal multiplier to an output from the Q′ signal multiplier.

According to the thus constructed multipath simulator, an I′ signal D/A converter converts the output from the I′ signal summing unit of the filter into an analog I′ signal at the sampling frequency. A Q′ signal D/A converter converts the output from the Q′ signal summing unit of the filter into an analog Q′ signal at the sampling frequency. An I′ signal multiplier multiplies the analog I′ signal by an RF signal with the RF modulation angular frequency. A Q′ signal multiplier multiplies the analog Q′ signal by an orthogonal RF signal with the same frequency as the RF signal and orthogonal in phase to the RF signal. An adder that adds an output from the I′ signal multiplier to an output from the Q′ signal multiplier.

According to the present invention, a multipath simulator includes: a signal converting unit that converts a digital I signal and a digital Q signal into a digital I′ signal and a digital Q′ signal based upon path delay periods and path ratios of respective paths, a sampling frequency of the digital I signal and the digital Q signal, and an RF modulation angular frequency used to modulate the digital I signal and the digital Q signal; an I′ signal D/A converter that converts the digital I′ signal into an analog I′ signal at the sampling frequency; a Q′ signal D/A converter that converts the digital Q′ signal into an analog Q′ signal at the sampling frequency; an I′ signal multiplier that multiplies the analog I′ signal by an RF signal with the RF modulation angular frequency; a Q′ signal multiplier that multiplies the analog Q′ signal by an orthogonal RF signal with the same frequency as the RF signal and orthogonal in phase to the RF signal; and an adder that adds an output from the I′ signal multiplier to an output from the Q′ signal multiplier.

According to the thus constructed multipath simulator, a signal converting unit converts a digital I signal and a digital Q signal into a digital I′ signal and a digital Q′ signal based upon path delay periods and path ratios of respective paths, a sampling frequency of the digital I signal and the digital Q signal, and an RF modulation angular frequency used to modulate the digital I signal and the digital Q signal. An I′ signal D/A converter converts the digital I′ signal into an analog I′ signal at the sampling frequency. A Q′ signal D/A converter converts the digital Q′ signal into an analog Q′ signal at the sampling frequency. An I′ signal multiplier that multiplies the analog I′ signal by an RF signal with the RF modulation angular frequency. A Q′ signal multiplier multiplies the analog Q′ signal by an orthogonal RF signal with the same frequency as the RF signal and orthogonal in phase to the RF signal. An adder that adds an output from the I′ signal multiplier to an output from the Q′ signal multiplier.

According to the present invention, a filter coefficient generating method includes: an impulse response generating step of, based upon path delay periods of respective paths and a sampling frequency of a digital I signal and a digital Q signal, generating a discrete impulse response based upon the sampling frequency for a digital filter realizing the path delay periods, the impulse response generating step being performed by an impulse response generating unit; a path ratio multiplying step, performed by a path ratio multiplying unit, of multiplying the impulse response by a path ratio; a phase rotating step, performed by a phase rotating unit, of reversely rotating a phase of an output from the path ratio multiplying step by (RF modulation angular frequency)×(path delay period); a real part accumulating step, performed by a real part accumulating unit, of accumulating a real part of an output from the phase rotating step; and an imaginary part accumulating step, performed by an imaginary part accumulating unit, of accumulating an imaginary part of the output from the phase rotating step, wherein: it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).

The present invention is a program of instructions for execution by the computer to perform a process, the process including: an impulse response generating step of, based upon path delay periods of respective paths and a sampling frequency of a digital I signal and a digital Q signal, generating a discrete impulse response based upon the sampling frequency for a digital filter realizing the path delay periods; a path ratio multiplying step of multiplying the impulse response by a path ratio; a phase rotating step of reversely rotating a phase of an output from the path ratio multiplying step by (RF modulation angular frequency)×(path delay period); a real part accumulating step of accumulating a real part of an output from the phase rotating step; and an imaginary part accumulating step of accumulating an imaginary part of the output from the phase rotating step, wherein: it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).

According to the present invention, a computer-readable medium has a program of instructions for execution by the computer to perform a process, the process including: an impulse response generating step of, based upon path delay periods of respective paths and a sampling frequency of a digital I signal and a digital Q signal, generating a discrete impulse response based upon the sampling frequency for a digital filter realizing the path delay periods; a path ratio multiplying step of multiplying the impulse response by a path ratio; a phase rotating step of reversely rotating a phase of an output from the path ratio multiplying step by (RF modulation angular frequency)×(path delay period); a real part accumulating step of accumulating a real part of an output from the phase rotating step; and an imaginary part accumulating step of accumulating an imaginary part of the output from the phase rotating step, wherein: it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).

### BRIEF DESCRIPTION OF THE DRAWINGS

FIG. 1 is a functional block diagram showing a configuration of a multipath simulator 1 according to the embodiment of the present invention;

FIG. 2 is a conceptual view of a multipath;

FIG. 3 shows an example of recorded contents of the path table recording section 12;

FIG. 4 is a functional block diagram showing a configuration of the filter coefficient generating section 14

FIG. 5 is a functional block diagram showing a configuration of a general FIR filter (tap number=13);

FIG. 6 is a descriptive chart of the phase rotation;

FIG. 7 is a functional block diagram showing a configuration of the FIR filter 16; and

FIG. 8 is a flowchart showing the operation of the filter coefficient generating section 14.

### PREFERRED EMBODIMENTS

A description will now be given of an embodiment of the present invention with reference to drawings.

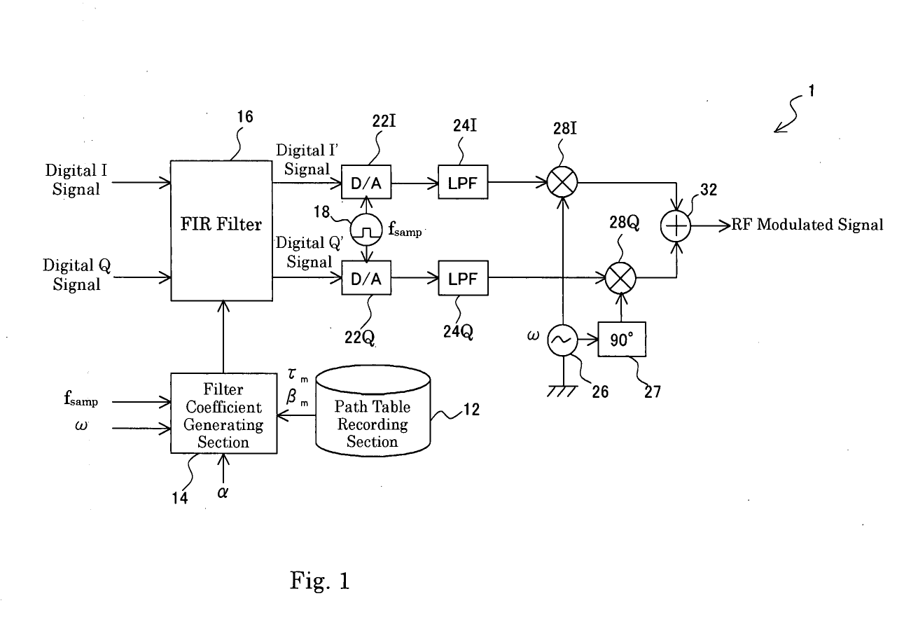

FIG. 1 is a functional block diagram showing a configuration of a multipath simulator 1 according to the embodiment of the present invention. The multipath simulator 1 is provided with a path table recording section 12, a filter coefficient generating section 14, an FIR filter 16, a sampling clock generator 18, an I′ signal D/A converter 22I, a Q′ signal D/A converter 22Q, low-pass filters 24I and 24Q, an RF signal generator 26, a 90-degree phase shifter 27, an I′ signal multiplier 281, a Q′ signal multiplier 28Q, and an adder 32.

The path table recording section 12 records a path number m, a path size (also referred to as “path ratio”) βₘ, an original delay period, and a path delay period τₘ of the respective paths of a multipath.

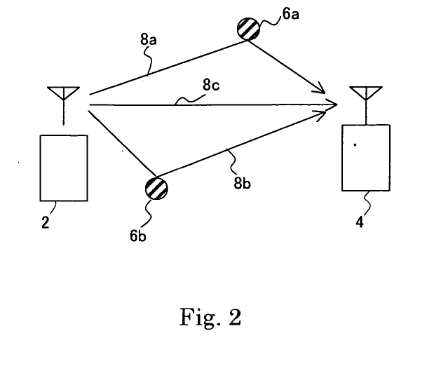

FIG. 2 is a conceptual view of a multipath. If a transmitter 2 wirelessly transmits a signal to a receiver 4, it is preferable that the signal follows a single path 8c. However, the signal is reflected by objects 6a and 6b, and thus reaches the receiver 4 routing through paths 8a and 8b. The multipath implies this type of phenomenon where the signal reaches the receiver 4 from the transmitter 2 via the multiple paths. If a multipath is present, the signal, which passes the straight path 8c from the transmitter 2 to the receiver 4, reaches the receiver 4 in a shorter period than the signals passing the paths 8a and 8b. Moreover, regardless of the paths 8a, 8b, and 8c which the signal passes, a level of the signal received by the receiver 4 (a level of the signal which has passed a path) is lower than a level of the signal to be transmitted from the transmitter 2 (a level of the signal which is to be input to the path).

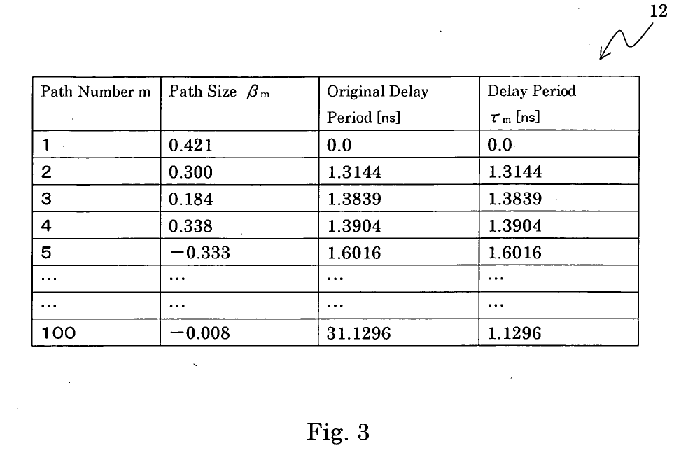

FIG. 3 shows an example of recorded contents of the path table recording section 12. The example appearing in FIG. 3 shows contents modeled according to IEEE 802.15.3a.

Although path number m ranges 1, 2, . . . , 100, they are shown by way of a simple example, and the number may exceed 100. Note that a path assigned with the path number m=1 indicates a path via which a signal reaches in the shortest period.

More over, it is assumed that an RF modulated signal obtained by modulating a digital I signal and a digital Q signal shown in FIG. 1 with an RF modulation angular frequency ω passes the paths with the path number m=1, 2, . . . , 100, and the path sizes βₘ and original delay periods of these paths then can be obtained. The RF modulated signal is obtained by causing a multiplier X to multiply the digital I signal by a signal A with the RF modulation angular frequency ω, causing a multiplier Y to multiply the digital Q signal by a signal B obtained by shifting the phase of the signal A by 90 degrees, and adding a multiplied result of the multiplier X and a multiplied result of the multiplier Y to each other.

The path size βₘ is defined as (a level of a signal having passed a path)/(a level of the signal to be input to the path). For example, the size of a path is a level of a signal which has passed the path if the level of the signal to be input to the path is 1 [V]. A level of a signal having passed a path has a negative or positive sign, and the path size βₘ thus takes a negative or positive value. For example, the path sizes βₘ of the paths with the path number m=1 to 4 are positive while the path sizes βₘ of the paths with the path number m=5 and 100 are negative.

The original delay period indicates a time difference between a period required to pass the path with the path number m=1, and a period required to pass another path (with the path number m=2, 3, . . . , 100). In the example shown in FIG. 3, the original delay period increases as the path number m increases.

The delay period τₘ is a remainder obtained by dividing the original delay period by a sampling period T(=1/fₛₐₘₚ) which is a reciprocal number of a sampling frequency fₛₐₘₚ of the digital I signal and the digital Q signal. It is herein assumed that T=10 [ns]. For example, for the path number m=100 in FIG. 3, the original delay period=31.1296 [ns], 31.1296=3×10+1.1296, and thus the delay period τ₁₀₀=1.1296 [ns].

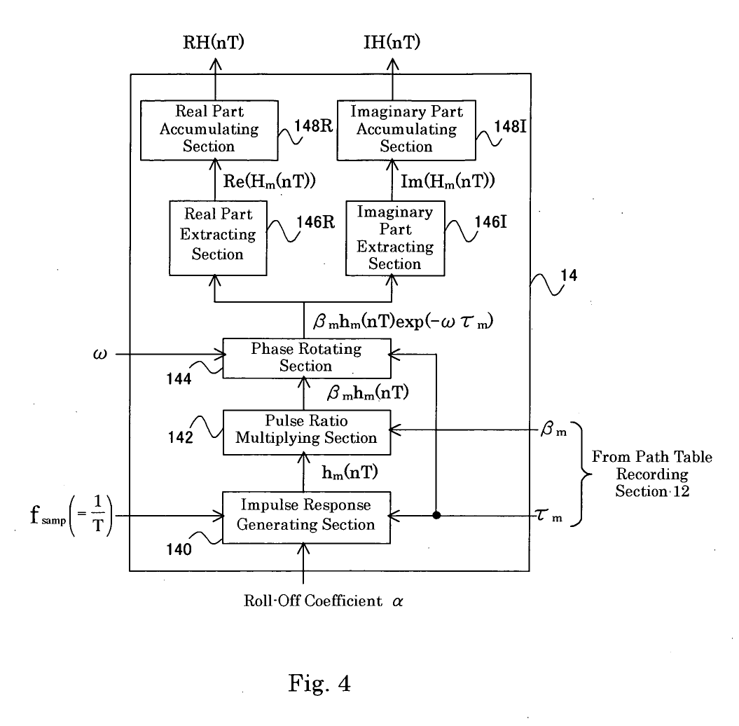

FIG. 4 is a functional block diagram showing a configuration of the filter coefficient generating section 14. The filter coefficient generating section 14 is provided with an impulse response generating section 140, a pulse ratio multiplying section 142, a phase rotating section 144, a real part extracting section 146R, an imaginary part extracting section 146I, a real part accumulating section 148R, and an imaginary part accumulating section 148I. The filter coefficient generating section 14 is used to generate a filter coefficient used in the FIR filter 16.

The impulse response generating section 140, based upon the path delay period τₘ of the respective paths and the sampling frequency fₛₐₘₚ of the digital I signal and the digital Q signal, generates discrete impulse responses of a Nyquist filter based upon the sampling frequency fₛₐₘₚ to realize the path delay periods τₘ. The path delay periods τₘ are read out from the path table recording section 12. A description will now be given of the method of generating this impulse response.

The impulse response of the Nyquist filter is represented by Equation (1).

$$h ( t ) = \frac{sin ( π \cdot t / {T}_{synq} )}{π \cdot t / {T}_{synq}} \times \frac{cos ( α \cdot π \cdot t / {T}_{synq} )}{1 - ( 2 α \cdot t / {T}_{synq} )} \qquad ( 1 )$$

Note that α denotes a roll-off coefficient, and T_{synq} denotes a Nyquist interval (or symbol interval). On this occasion, it is only necessary to shift the time of the impulse response by τ to generate a delay filter with a delay period τ. The impulse response is thus changed to Equation (2).

$$h ( t ) = \frac{sin ( π \cdot ( t - τ ) / {T}_{synq} )}{π \cdot ( t - τ ) / {T}_{synq}} \times \frac{cos ( α \cdot π \cdot ( t - τ ) / {T}_{synq} )}{1 - ( 2 α \cdot ( t - τ ) / {T}_{synq} )} \qquad ( 2 )$$

The impulse response is then made into a discrete form based upon the sampling frequency fₛₐₘₚ. Since T=1/fₛₐₘₚ, Equation (2) can be transformed into Equation (3).

$$h ( nT ) = \frac{sin ( π \cdot ( nT - τ ) / {T}_{synq} )}{π \cdot ( nT - τ ) / {T}_{synq}} \times \frac{cos ( α \cdot π \cdot ( nT - τ ) / {T}_{synq} )}{1 - ( 2 α \cdot ( nT - τ ) / {T}_{synq} )} \qquad ( 3 )$$

In this equation, it is assumed that the Nyquist interval T_{synq}=the sampling period T. As a result, Equation (3) can be transformed into Equation (4).

$$h ( nT ) = \frac{sin ( π \cdot ( nT - τ ) / T )}{π \cdot ( nT - τ ) / T} \times \frac{cos ( α \cdot π \cdot ( nT - τ ) / T )}{1 - ( 2 α \cdot ( nT - τ ) / T )} \qquad ( 4 )$$

Since the delay period τ is actually the pass delay period τₘ, Equation (5) below is obtained by replacing τ in Equation (4) by τₘ. An impulse response hₘ(nT) is generated by assigning the roll-off coefficient α, the path delay period τₘ, and the sampling period T to Equation (5).

$${h}_{m} ( nT ) = \frac{sin ( π \cdot ( nT - {τ}_{m} ) / T )}{π \cdot ( nT - {τ}_{m} ) / T} \times \frac{cos ( α \cdot π \cdot ( nT - {τ}_{m} ) / T )}{1 - ( 2 α \cdot ( nT - {τ}_{m} ) / T )} \qquad ( 5 )$$

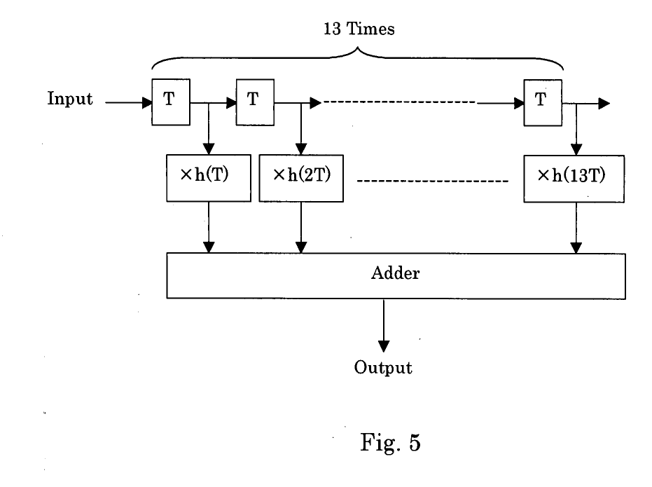

A description will now be given of implication of the impulse response h(nT) with reference to FIG. 5. FIG. 5 is a functional block diagram showing a configuration of a general FIR filter (tap number=13). Note that the FIR filter may be a Nyquist filter. A Nyquist filter is a type of digital filters. h(nT) (n=1, . . . , 13) denotes a discrete impulse response based upon the sampling frequency fₛₐₘₚ.

The FIR filter shown in FIG. 5 is configured such that an adder sums an input delayed by T and then multiplied by h(T), an input delayed by 2T and then multiplied by h(2T), . . . , and an input delayed by 13T and then multiplied by h(13T), and then outputs a summed result.

If it is assumed that τ=0 [ns] in Equation (4), h(T), h(2T), . . . , h(13T) are then obtained, and are assigned to h(T), h(2T), . . . , h(13T) of the FIR filter shown in FIG. 5. As a result, the output from the FIR filter shown in FIG. 5 is delayed with respect to the input by T×(13−1)/2=60 [ns].

Moreover, in Equation (4), h(T), h(2T), . . . , h(13T) are obtained while it is assumed that τ=1.13144 [ns], and are assigned to h(T), h(2T), h(13T) of the FIR filter shown in FIG. 5. As a result, the output from the FIR filter shown in FIG. 5 is delayed with respect to the input by T×(13−1)/2+τ=61.13144 [ns]. Namely, the output is delayed with respect to the case of τ=0 [ns] by 1.13144 [ns].

Further, τ₁=0.0 [ns] is assigned to Equation (5), h₁(T), h₁(2T), . . . , h₁(13T) are obtained, and are assigned to h(T), h(2T), . . . , h(13T) of the FIR filter shown in FIG. 5. As a result, the output from the FIR filter shown in FIG. 5 is delayed with respect to the input by T×(13−1)/2=60 [ns].

Further, τ₂=1.13144 [ns] is assigned to Equation (5), h₂(T), h₂(2T), . . . , h₂(13T) are obtained, and are assigned to h(T), h(2T), . . . , h(13T) of the FIR filter shown in FIG. 5. As a result, the output from the FIR filter shown in FIG. 5 is delayed with respect to the case of assigning τ₁=0.0 [ns] to Equation (5) by 1.13144 [ns].

Further, τ₃=1.3839 [ns] is assigned to Equation (5), h₃(T), h₃(2T), . . . , h₃(13T) are obtained, and are assigned to h(T), h(2T), . . . , h(13T) of the FIR filter shown in FIG. 5. As a result, the output from the FIR filter shown in FIG. 5 is delayed with respect to the case of assigning τ₁=0.0 [ns] to Equation (5) by 1.3839 [ns].

If it is assumed that h(T)=h₁(T)+h₂(T)+h₃(T), h(2T)=h₁(2T)+h₂(2T)+h₃(2T), . . . , h(13T)=h₁(13T)+h₂(13T)+h₃(13T), in the FIR filter shown in FIG. 5, it is possible to obtain an output by summing the cases of delaying the input by τ₁=0.0 [ns], τ₂=1.13144 [ns], and τ₃=1.3839 [ns].

The path ratio multiplying section 142 receives the impulse response hₘ(nT) from the impulse response generating section 140, and multiplies the impulse response hₘ(nT) by the path ratio βₘ. Note that the path ratio τₘ is read out from the path table recording section 12.

If it is assumed that h(T)=β₁h₁(T)+β₂h₂(T)+β₃h₃(T), h(2T)=β₁h₁(2T)+β₂h₂(2T)+β₃h₃(2T), . . . , h(13T)=β₁h₁(13T)+β₂h₂(13T)+β₃h₃(13T), in the FIR filter shown in FIG. 5, it is possible to obtain an output by summing the cases of delaying the input by τ₁=0.0 [ns], and then multiplying the delayed result by β₁, delaying the input by β₂=1.13144 [ns], and then multiplying the delayed result by β₂, and delaying the input by τ₃=1.3839 [ns], and then multiplying the delayed result by β₃.

Similarly, if it is assumed that h(T)=β₁h₁(T)+β₂h₂(T)+ . . . +β₁₀₀h₁₀₀(T), h(2T)=β₁h₁(2T)+β₂h₂(2T)+ . . . +β₁₀₀h₁₀₀(2T), . . . , h(13T)=β₁h₁(13T)+β₂h₂(13T)+ . . . +β₁₀₀h₁₀₀(13T), in the FIR filter shown in FIG. 5, it is possible to obtain an output by summing the cases of delaying the input by τ₁=0.0 [ns], and then multiplying the delayed result by β₁, delaying the input by β₂=1.13144 [ns], and then multiplying the delayed result by β₂, . . . , and delaying the input by τ₁₀₀=1.1296 [ns], and then multiplying the delayed result by β₁₀₀.

If the RF modulated signal which is obtained by modulating the digital I signal and the digital Q signal with the RF modulation angular frequency ω is supplied to the FIR filter shown in FIG. 5, h(T), h(2T), . . . , h(13T) are to be obtained in this way. However, it is necessary to shift the phase of the output βₘhₘ(nT) from the path ratio multiplying section 142 in order to supply the digital I signal and the digital Q signal to the FIR filter 16 in the present embodiment. An output from the path ratio multiplying section 142 is thus supplied to the phase rotating section 144.

The phase rotating section 144 reversely rotates the phase of the output βₘhₘ(nT) from the path ratio multiplying section 142 by (RF modulation angular frequency ω)×(path delay period τₘ). Namely, the phase rotating section 144 multiplies βₘhₘ(nT) by exp(−ωτₘ), and outputs a multiplied result.

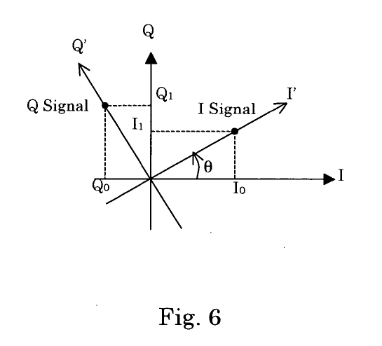

FIG. 6 is a descriptive chart of the phase rotation. FIG. 6 is a sectional view parallel to an IQ plane taken at a certain time point t0. If the RF modulation is not considered, the digital I signal and the digital Q signal are respectively present upon an I-t plane and a Q-t plane (t denotes time). In FIG. 6, they are present upon the I and Q axes. However, if the RF modulation is considered, their phases rotate, and the digital I signal and the digital Q signal are respectively present upon I′ and Q′ axes. The I′ axis (Q′ axis) is a consequence of rotating the I axis (Q axis) by θ=−ωτₘ.

A real part extracting section 146R extracts a real part from an output βₘhₘ(nT)exp(−ωτₘ) supplied from the phase rotating section 144. An imaginary part extracting section 146I extracts an imaginary part from the output βₘhₘ(nT)exp(−ωτₘ) supplied from the phase rotating section 144.

A real part accumulating section 148R receives the real part of the output supplied from the phase rotating section 144 from the real part extracting section 146R, and accumulates the real parts. An imaginary part accumulating section 148I receives the imaginary part of the output supplied from the phase rotating section 144 from the imaginary part extracting section 146I, and accumulates the imaginary parts. An output RH(nT) from the real part accumulating section 148R is represented by Equation (6), and an output IH(nT) from the imaginary part accumulating section 1481 is represented by Equation (7). Note that Hₘ(nT)=βₘhₘ(nT)exp(−ωτₘ).

$$\begin{matrix}RH ( nT ) = {\sum }_{m = 1}^{100} Re ( {H}_{m} ( nT ) ) & ( 6 ) \\ IH ( nT ) = {\sum }_{m = 1}^{100} Im ( {H}_{m} ( nT ) ) & ( 7 )\end{matrix}$$

If the original delay period=the path delay period τₘ for all the path numbers m, RH(nT) and IH(nT) are obtained based upon Equations (6) and (7).

However, if there is a path number m′ for which the original delay period>the path delay period τ_{m′}, H_{m′}(nT) is replaced by H_{m′}((n−k)T). Note that k is the maximum integer equal to or lower than a value obtained by dividing the original delay period by the sampling period T (10 [ns] in the present embodiment). For example, if the original delay period=31.1296 [ns] for the path number 100, and this value is larger than the delay period τ₁₀₀=1.1296 [ns]. Since 31.1296/10=3.11296, k=3. If H_{m′}(nT) is replaced by H_{m′}((n−k)T), Re(H_{m′}(nT)) and Im(H_{m′}(nT)) are respectively represented by Equations (8) and (9).
Re(H_{m′}(nT))=Re(H_{m′}((n−k)T)) (8)
Im(H_{m′}(nT))=Im(H_{m′}((n−k)T)) (9)

For example, it is assumed that the original delay period>the path delay period τ_{m′} only for the path number 100, and the original delay period=the path delay period τₘ for the other path numbers 1 to 99. Moreover, if the original delay period=the path delay period τₘ for all the path numbers m, it is assumed that n is an integer ranging from 1 to 13.

The following Equation (10) is thus obtained by assigning k=3 to Equation (8). Although Re(H₁₀₀(nT)) is defined (Im(H₁₀₀(nT) is defined similarly) according to Equation (10) for 4≦n≦16, Re(H₁₀₀(nT)) cannot be defined according to Equation (10) for 1≦n≦3. It is thus assumed that Re(H₁₀₀(nT))=0 for 1≦n≦3 as Equation (11) shows (the same is applied to Im(H₁₀₀(nT))). Further, since Hm(nT) is not defined for 13<n (note that m=1 to 99), it is also assumed that Hₘ(nT) is 0 as Equation (12) shows (the same is applied to Im(Hₘ(nT))).
Re(H₁₀₀(nT))=Re(H₁₀₀((n−3)T)) (1≦n−3≦13) (10)
Re(H₁₀₀(nT))=0 (1≦n≦3) (11)
Re(Hₘ(nT))=0 (m≠100 and 13<n) (12)
Here, m′=100, k=3

If Equations (10), (11), and (12) are applied to Equation (6), the output RH(nT) from the real part accumulating section 148R is represented by Equation (13). Note that n ranges from 1 to 16.
RH(T)=Re(H₁(T))+ . . . +Re(H₉₉(T))+0
. . .
RH(3T)=Re(H₁(3T))+ . . . +Re(H₉₉(3T))+0
RH(4T)=Re(H₁(4T))+ . . . +Re(H₉₉(4T))+Re(H₁₀₀(T))
. . .
RH(13T)=Re(H₁(13T))+ . . . +Re(H₉₉(13T))+Re(H₁₀₀(10T))
RH(14T)=0+ . . . +0+Re(H₁₀₀(11T))
. . .
RH(16T)=0+ . . . +0+Re(H₁₀₀(13T)) (13)

In this way, the real part accumulating section 148R and the imaginary part accumulating section 148I change the subjects to be accumulated according to the maximum integer number k obtained by dividing the original delay period by the sampling period T. With reference to Equation (13), the real part accumulating section 148R accumulates Re(Hₘ(T)) (m=1 to 99) reflecting that k=3 (only for m=100) in place of accumulating Re(Hₘ(T)) (m=1 to 100)(refer to Equation (6)) in order to obtain RH(T). The real part accumulating section 148R accumulates Re(Hₘ(4T)) (m=1 to 99) and Re(H₁₀₀(T)) reflecting that k=3 (only for m=100) in place of accumulating Re(Hₘ(4T)) (m=1 to 100) (refer to Equation (6)) in order to obtain RH(4T). The same is applied to the imaginary part accumulating section 148I.

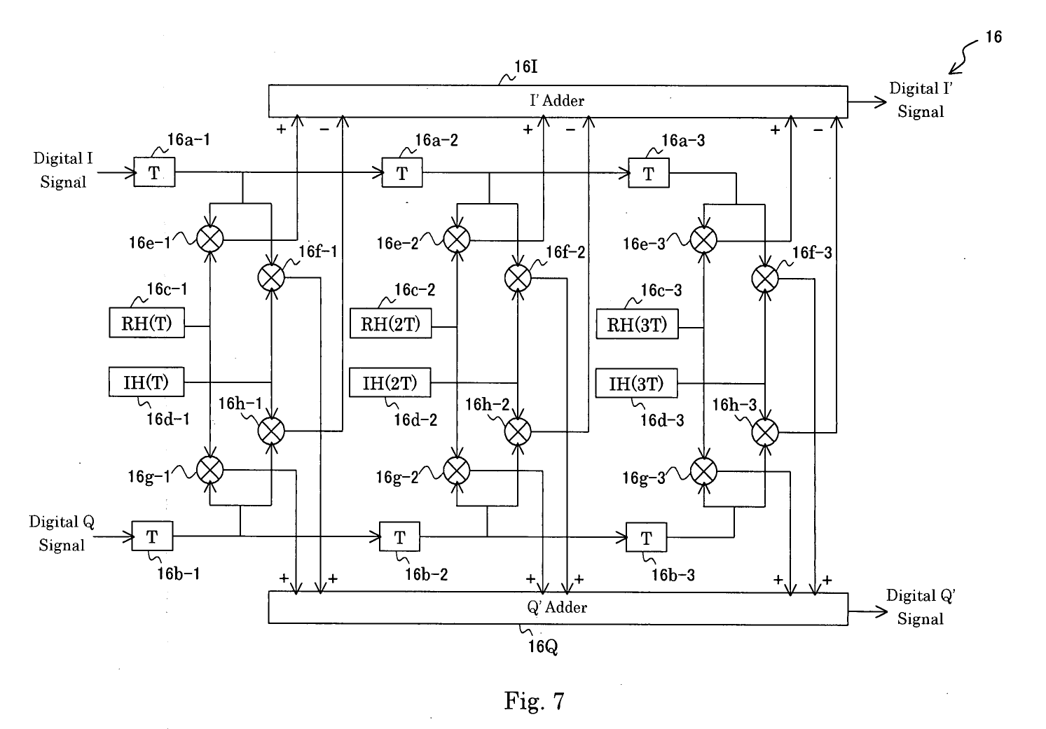

FIG. 7 is a functional block diagram showing a configuration of the FIR filter 16. Note that FIG. 7 shows an example where the number of taps is three. However, the number of the taps is not limited to three, and the number may be four or more. The FIR filter 16 receives the digital I signal and the digital Q signal, and converts them respectively into a digital I′ signal and a digital Q′ signal.

The FIR filter 16 is provided with I signal delaying taps 16a-1, 16a-2, and 16a-3, Q signal delaying taps 16b-1, 16b-2, and 16b-3, real coefficient recording sections 16c-1, 16c-2, and 16c-3, imaginary coefficient recording sections 16d-1, 16d-2, and 16d-3, I signal real part multipliers 16e-1, 16e-2, and 16e-3, I signal imaginary part multipliers 16f-1, 16f-2, and 16f-3, Q signal real part multipliers 16g-1, 16g-2, and 16g-3, Q signal imaginary part multipliers 16h-1, 16h-2, and 16h-3, an I′ adder (I′ signal summing means) 16I, and a Q′ adder (Q′ signal summing means) 16Q.

The I signal delaying taps 16a-1, 16a-2, and 16a-3 delay the digital I signal by the sampling period T(=1/fₛₐₘₚ) of the digital I signal. Namely, the I signal delaying tap 16a-1 delays the digital I signal by the sampling period T, and outputs a delayed signal, the I signal delaying tap 16a-2 further delays the output from the I signal delaying tap 16a-1 by the sampling period T, and outputs a delayed signal (resulting in delaying the digital I signal by the sampling period 2T and outputting the delayed signal), and the I signal delaying tap 16a-3 further delays the output from the I signal delaying tap 16a-2 by the sampling period T, and outputs a delayed signal (resulting in delaying the digital I signal by the sampling period 3T and outputting the delayed signal).

The Q signal delaying taps 16b-1, 16b-2, and 16b-3 delay the digital Q signal by the sampling period T(=1/fₛₐₘₚ) of the digital Q signal. Namely, the Q signal delaying tap 16b-1 delays the digital Q signal by the sampling period T, and outputs the delayed signal, the Q signal delaying tap 16b-2 further delays the output from the Q signal delaying tap 16b-1 by the sampling period T, and outputs the delayed signal (resulting in delaying the digital Q signal by the sampling period 2T and outputting the delayed signal), and the Q signal delaying tap 16b-3 further delays the output from the Q signal delaying tap 16b-2 by the sampling period T, and outputs the delayed signal (resulting in delaying the digital Q signal by the sampling period 3T and outputting the delayed signal).

The real coefficient recording sections 16c-1, 16c-2, and 16c-3 record the output from the real part accumulating section 148R. The real coefficient recording section 16c-1 receives and records RH(T) from the real part accumulating section 148R. The real coefficient recording section 16c-2 receives and records RH(2T) from the real part accumulating section 148R. The real coefficient recording section 16c-3 receives and records RH(3T) from the real part accumulating section 148R. Note that the number of the real coefficient recording sections may exceed three, and the real coefficient recording sections receive and record RH(nT) from the real part accumulating section 148R. The number of the real coefficient recording sections matches the maximum number n of RH(nT) output from the real part accumulating section 148R. If the output from the real part accumulating section 148R is expressed by Equation (13), there are provided 16 of the real coefficient recording sections. Note that the numbers of the imaginary coefficient recording sections, the I signal delaying taps and the Q signal delaying taps are the same as the number of the real coefficient recording sections, and 16 of them are respectively to be provided.

The imaginary coefficient recording sections 16d-1, 16d-2, and 16d-3 record the output from the imaginary part accumulating section 148I. The imaginary coefficient recording section 16d-1 receives and records IH(T) from the imaginary part accumulating section 1481. The imaginary coefficient recording section 16d-2 receives and records IH(2T) from the imaginary part accumulating section 1481. The imaginary coefficient recording section 16d-3 receives and records IH(3T) from the imaginary part accumulating section 1481. Note that the number of the imaginary coefficient recording sections may exceed three, and the imaginary coefficient recording sections receive and record IH(nT) from the imaginary part accumulating section 148I. The number of the imaginary coefficient recording sections matches the maximum number n of IH(nT) output from the imaginary part accumulating section 148I. If the output from the real part accumulating section 148R is expressed by Equation (13), the output from the imaginary part accumulating section 148I is similar thereto, and there are provided 16 of the imaginary coefficient recording sections.

The I signal real part multipliers 16e-1, 16e-2, and 16e-3 respectively multiply outputs from the I signal delaying taps 16a-1, 16a-2, and 16a-3 by predetermined real part coefficients, and output multiplied results. The predetermined real coefficients are RH(nT) respectively recorded in the real coefficient recording sections 16c-1, 16c-2, and 16c-3.

The I signal real part multiplier 16e-1 multiplies the output from the I signal delaying tap 16a-1 by the predetermined real part coefficient RH(T) recorded in the real coefficient recording section 16c-1. The I signal real part multiplier 16e-2 multiplies the output from the I signal delaying tap 16a-2 by the predetermined real part coefficient RH(2T) recorded in the real coefficient recording section 16c-2. The I signal real part multiplier 16e-3 multiplies the output from the I signal delaying tap 16a-3 by the predetermined real part coefficient RH(3T) recorded in the real coefficient recording section 16c-3.

The I signal imaginary part multipliers 16f-1, 16f-2, and 16f-3 respectively multiply outputs from the I signal delaying taps 16a-1, 16a-2, and 16a-3 by predetermined imaginary part coefficients, and output multiplied results. The predetermined imaginary parts are IH(nT) respectively recorded in the imaginary coefficient recording sections 16d-1, 16d-2, and 16d-3.

The I signal imaginary part multiplier 16f-1 multiplies the output from the I signal delaying tap 16a-1 by the predetermined imaginary part coefficient IH(T) recorded in the imaginary coefficient recording section 16d-1. The I signal imaginary part multiplier 16f-2 multiplies the output from the I signal delaying tap 16a-2 by the predetermined imaginary part coefficient IH(2T) recorded in the imaginary coefficient recording section 16d-2. The I signal imaginary part multiplier 16f-3 multiplies the output from the I signal delaying tap 16a-3 by the predetermined imaginary part coefficient IH(3T) recorded in the imaginary coefficient recording section 16d-3.

The Q signal real part multipliers 16g-1, 16g-2, and 16g-3 respectively multiply outputs from the Q signal delaying taps 16b-1, 16b-2, and 16b-3 by the predetermined real part coefficients, and output multiplied results.

The Q signal real part multiplier 16g-1 multiplies the output from the Q signal delaying tap 16b-1 by the predetermined real part coefficient RH(T) recorded in the real coefficient recording section 16c-1. The Q signal real part multiplier 16g-2 multiplies the output from the Q signal delaying tap 16b-2 by the predetermined real part coefficient RH(2T) recorded in the real coefficient recording section 16c-2. The Q signal real part multiplier 16g-3 multiplies the output from the Q signal delaying tap 16b-3 by the predetermined real part coefficient RH(3T) recorded in the real coefficient recording section 16c-3.

The Q signal imaginary part multipliers 16h-1, 16h-2, and 16h-3 respectively multiply outputs from the Q signal delaying taps 16b-1, 16b-2, and 16b-3 by the predetermined imaginary part coefficients, and output multiplied results.

The Q signal imaginary part multiplier 16h-1 multiplies the output from the Q signal delaying tap 16b-1 by the predetermined imaginary part coefficient IH(T) recorded in the imaginary coefficient recording section 16d-1. The Q signal imaginary part multiplier 16h-2 multiplies the output from the Q signal delaying tap 16b-2 by the predetermined imaginary part coefficient IH(2T) recorded in the imaginary coefficient recording section 16d-2. The Q signal imaginary part multiplier 16h-3 multiplies the output from the Q signal delaying tap 16b-3 by the predetermined imaginary part coefficient IH(3T) recorded in the imaginary coefficient recording section 16d-3.

The I′ adder 16I subtracts a sum of the outputs supplied from the Q signal imaginary part multipliers 16h-1, 16h-2, and 16h-3, from a sum of the outputs supplied from the I signal real part multipliers 16e-1, 16e-2, and 16e-3, and outputs a result of the subtraction. The output from the I′ adder 16I is the digital I′ signal.

The Q′ adder 16Q adds a sum of the outputs supplied from the I signal imaginary part multipliers 16f-1, 16f-2, and 16f-3, to a sum of the outputs supplied from the Q signal real part multipliers 16g-1, 16g-2, and 16g-3, and outputs a result of the addition. The output from the Q′ adder 16Q is the digital Q′ signal.

The digital I′ signal and the digital Q′ signal are signals reflecting the path delay periods τₘ, the path sizes βₘ, and the phase rotations exp(−ωτₘ) of the respective paths of the multipath.

It is previously described that if it is assumed that h(T)=β₁h₁(T)+β₂h₂(T)+ . . . +β₁₀₀h₁₀₀(T), h(2T)=β₁h₁(2T)+β₂h₂(2T)+ . . . +β₁₀₀h₁₀₀(2T), . . . , h(13T)=β₁h₁(13T)+β₂h₂(13T)+ . . . +β₁₀₀h₁₀₀(13T), in the FIR filter shown in FIG. 5, it is possible to obtain the output by summing the cases of delaying the input by τ₁=0.0 [ns], and then multiplying the delayed result by β₁, delaying the input by τ₂=1.13144 [ns], and then multiplying the delayed result by β₂, . . . , and delaying the input by τ₁₀₀=1.1296 [ns], and then multiplying the delayed result by β₁₀₀. It is thus the path delay period τₘ and the path size βₘ are reflected.

A description will now be given of a method to reflect the phase rotation exp(−ωτₘ) with reference to FIG. 6. The following is necessary to convert the digital I signal and the digital Q signal respectively present on the I′ axis and the Q′ axis to the signals (digital I′ signal and digital Q′ signal) present on the I axis and the Q axis.
Digital I′ signal=I₀−Q₀=I cos θ−Q sin θ=I·Re(exp(jθ))−Q·Im(exp(jθ))
Digital Q′ signal=I₁+Q₁=I sin θ+Q cos θ=I·Im(exp(jθ))+Q·Re(exp(jθ))
where θ=−ωτₘ.

Namely, the digital I′ signal is obtained by subtracting a product of the digital Q signal and an imaginary part of the phase rotation exp(jθ) from a product of the digital I signal and a real part of the phase rotation exp(jθ). The digital Q′ signal is obtained by adding a product of the digital I signal and the imaginary part of the phase rotation exp(jθ) to a product of the digital Q signal and the real part of the phase rotation exp(jθ).

With reference to FIG. 7, the I′ adder 161 subtracts the sum of the outputs supplied from the Q signal imaginary part multiplies 16h-1, 16h-2, and 16h-3 (respectively obtained by multiplying the digital Q signal by the imaginary part of the phase rotation), from a sum of the outputs supplied from the I signal real part multipliers 16e-1, 16e-2, and 16e-3 (respectively obtained by multiplying the digital I signal by the real part of the phase rotation), and outputs the subtracted result. There is thus obtained the digital I′ signal reflecting the phase rotation.

The Q′ adder 16Q adds the sum of the outputs supplied from the I signal imaginary part multipliers 16f-1, 16f-2, and 16f-3 (respectively obtained by multiplying the digital I signal by the imaginary part of the phase rotation), to the sum of the outputs supplied from the Q signal real part multipliers 16g-1, 16g-2, and 16g-3 (respectively obtained by multiplying the digital Q signal by the real part of the phase rotation), and outputs the added result. There is thus obtained the digital Q′ signal reflecting the phase rotation.

With reference again to FIG. 1, the sampling clock generator 18 generates a clock signal with the sampling frequency fₛₐₘₚ for the digital I signal and the digital Q signal.

The I′ signal D/A converter 22I receives the clock signal from the sampling clock generator 18 to convert the digital I′ signal, which is the output from the I′ adder of the FIR filter 16, into an analog I′ signal at the sampling frequency fₛₐₘₚ. The Q′ signal D/A converter 22Q receives the clock signal from the sampling clock generator 18 to convert the digital Q′ signal, which is the output from the Q′ adder of the FIR filter 16, into an analog Q′ signal at the sampling frequency fₛₐₘₚ.

A digital signal is obtained by sampling the analog signal at the sampling frequency fₛₐₘₚ. It is thus possible to restore the original analog signal to some extent from the digital signal if the sampling frequency fₛₐₘₚ is known.

The low-pass filter 24I removes high frequency components (such as noise) from an output supplied from the I′ signal D/A converter 22I. The low-pass filter 24Q removes high frequency components (such as noise) from an output supplied from the Q′ signal D/A converter 22Q.

The RF signal generator 26 generates an RF signal. An modulation angular frequency of the RF signal is ω.

The 90-degree phase shifter 27 shifts the phase of the RF signal by 90 degrees. However, the frequency thereof is not changed. A signal output from the 90-degree phase shifter 27 is referred to as an orthogonal RF signal.

The I′ signal multiplier 28I multiplies the analog I′ signal by the RF signal.

The Q′ signal multiplier 28Q multiplies the analog Q′ signal by the orthogonal RF signal.

The adder 32 adds an output from the I′ signal multiplier 28I to an output from the Q′ signal multiplier 28Q. As a result, it is possible to obtain a signal by composing the signals which are the RF modulated signals obtained by modulating the digital I signal and the digital Q signal with the RF modulation angular frequency ω, and having passed the respective paths with the number m=1, 2, . . . , 100.

A description will now be given of an operation of the embodiment of the present invention.

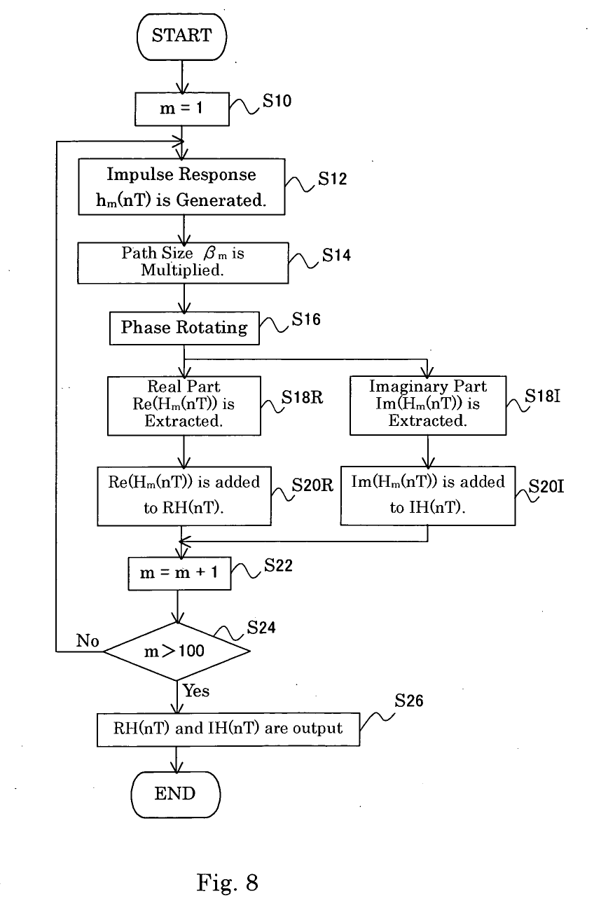

First, a description will be given of an operation of the filter coefficient generating section 14. FIG. 8 is a flowchart showing the operation of the filter coefficient generating section 14.

First, there is set that the path number m=1 (S10).

The impulse response generating section 140 of the filter coefficient generating section 14 then reads out the path size βₘ and the delay period τₘ of the path corresponding to the path number m from the path table recording section 12. The impulse response generating section 140 generates the impulse response hₘ(nT) (refer to Equation (5)) (S12).

The path ratio multiplying section 142 multiplies the impulse response hₘ(nT) by the path ratio βₘ (S14).

The phase rotating section 144 rotates the phase of the output βₘhₘ(nT) from the path ratio multiplying section 142 by (RF modulation angular frequency ω)×(path delay period τₘ) (S16).

The real part extracting section 146R extracts the real part Re(Hₘ(nT)) from the output βₘhₘ(nT)exp(−ωτₘ) supplied from the phase rotating section 144 (S18R).

The imaginary part extracting section 146I extracts the imaginary part Im(Hₘ(nT)) from the output βₘhₘ(nT)exp(−ωτₘ) supplied from the phase rotating section 144 (S18I).

The real part accumulating section 148R adds Re(Hₘ(nT)) to RH(nT) (initial value=0) (S20R). The imaginary part accumulating section 148I adds Im(Hₘ(nT)) to IH(nT) (initial value=0) (S20I).

The path number m is incremented by one (S22). If m<100 (“No” in S24), the operation returns to the generation of the impulse response (S12). In this way, the real part accumulating section 148R obtains RH(nT)=Re(H₁(nT))+Re(H₂(nT))+ . . . +Re(H₁₀₀(nT)). Namely, the real part accumulating section 148R accumulates the real parts of the output from the phase rotating section 144 (outputs from the real part extracting section 146R). The imaginary part accumulating section 148I obtains IH(nT)=Im(H₁(nT))+Im(H₂(nT))+ . . . +Im(H₁₀₀(nT)). Namely, the imaginary part accumulating section 148I accumulates the imaginary parts of the output from the phase rotating section 144 (outputs from the imaginary part extracting section 146I).

If the path number m is incremented by one (S22), and there arises a state of m>100 (“Yes” in S24), the accumulated result RH(nT) of the real part accumulating section 148R is output to the real coefficient recording section 16c-1, 16c-2, or 16c-3, and the accumulated result IH(nT) of the imaginary part accumulating section 148I is output to the imaginary coefficient recording section 16d-1, 16d-2, or 16d-3 of the FIR filter 16 (S26).

In this way, the filter coefficients for the FIR filter 16 are generated. There are acquired the recorded contents of the real coefficient recording sections 16c-1, 16c-2, and 16c-3, and the imaginary coefficient recording sections 16d-1, 16d-2, and 16d-3.

The multipath simulator 1 then operates.

The FIR filter 16 receives the digital I signal and digital Q signal, and converts them respectively into the digital I′ signal and the digital Q′ signal. The digital I′ signal and the digital Q′ signal are signals reflecting the path delay periods τₘ, the path sizes βₘ, and the phase rotations exp(−ωτₘ) of the respective paths of the multipath.

The I′ signal D/A converter 22I converts the digital I′ signal, which is the output from the I′ adder of the FIR filter 16, into the analog I′ signal at the sampling frequency fₛₐₘₚ. The Q′ signal D/A converter 22Q converts the digital Q′ signal, which is the output from the Q′ adder of the FIR filter 16, into the analog Q′ signal at the sampling frequency fₛₐₘₚ.

The low-pass filter 24I removes the high frequency components (such as noise) from the output supplied from the I′ signal D/A converter 22I. The low-pass filter 24Q removes the high frequency components (such as noise) from the output supplied from the Q′ signal D/A converter 22Q.

The I′ signal multiplier 28I multiplies the analog I′ signal by the RF signal with the RF modulation angular frequency ω.

The Q′ signal multiplier 28Q multiplies the analog Q′ signal by the orthogonal RF signal with the same frequency as the RF signal and orthogonal in phase to the RF signal.

The adder 32 adds the output from the I′ signal multiplier 28I to the output from the Q′ signal multiplier 28Q. As a result, it is possible to obtain the signal by composing the signals which are the RF modulated signals obtained by modulating the digital I signal and the digital Q signal with the RF modulation angular frequency ω, and having passed the respective paths with the number m=1, 2, . . . , 100. The signal obtained in this way is used for the simulation of a multipath (such as a simulation of fading).

According to the embodiment of the present invention, the simulation of a multipath is realized by (1) causing the filter coefficient generating section 14 to generate the filter coefficients RH(nT) and IH(nT) used in the FIR filter 16, (2) supplying the digital I signal and the digital Q signal to the FIR filter 16, and (3) converting the digital I′ signal and the digital Q′ signal output from the FIR filter 16 into the analog signals at the sampling frequency fₛₐₘₚ, and then carrying out the orthogonal modulation with the RF signal.

According to the embodiment, even if the number of the paths increases, the number of the components of the FIR filter 16 does not always increase, and the simulation of a multipath is realized by simple hardware.

The above description is given of the embodiment while it is assumed that the FIR filter 16 is a Nyquist filter. However the FIR filter 16 may be a Gaussian filter. In this case, the impulse response generating section 140 generates an impulse response according to the Gaussian filter. Although a method to generate the impulse response of the Gaussian filter is similar to that of the Nyquist filter, Equation (1) is different. An equation for the Gaussian filter corresponding to Equation (1) is well known, and a description thereof, therefore, is omitted. The FIR filter 16 may be realized by a digital filter such as a Nyquist filter or a Gaussian filter in this way. The impulse response generating section 140 thus generates an impulse response according to the digital filter.

Additionally, the embodiment described above may be realized in the following way. On a computer including a CPU, a hard disk, and a media (such as a floppy (registered trade mark) disk, and a CD-ROM) reading device, the media reading device may be caused to read a medium recording a program realizing the respective components described above (such as the path table recording section 12, the impulse response generating section 140, the path ratio multiplying section 142, the phase rotating section 144, the real part extracting section 146R, the imaginary part extracting section 146I, the real part accumulating section 148R, and the imaginary part accumulating section 148I), and the program may be installed on the hard disk. The embodiment described above may also be realized in this way.

1. A filter coefficient generating device comprising:
an impulse response generating means that, based upon path delay periods of respective paths and a sampling frequency of a digital I signal and a digital Q signal, generates a discrete impulse response based upon the sampling frequency for a digital filter realizing the path delay periods;
a path ratio multiplying means that multiplies the impulse response by a path ratio;
a phase rotating means that reversely rotates a phase of an output from said path ratio multiplying means by (RF modulation angular frequency)×(path delay period);
a real part accumulating means that accumulates a real part of an output from said phase rotating means; and
an imaginary part accumulating means that accumulates an imaginary part of the output from said phase rotating means,
wherein:
it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).

2. The filter coefficient generating device according to claim 1 wherein:
the digital filter is a Nyquist filter.

3. The filter coefficient generating device according to claim 1 wherein:
the path delay period is a remainder obtained by dividing a time difference between a period required for the RF modulated signal to pass a path and a period required for the RF modulated signal to pass another path by a sampling period which is a reciprocal of the sampling frequency.

4. The filter coefficient generating device according to claim 3 wherein:
said real part accumulating means and said imaginary part accumulating means change a subject to be accumulated according to the maximum integer number equal to or smaller than a value obtained by dividing the time difference by the sampling period.

5. A filter comprising:
an I signal delaying means that delays a digital I signal by a sampling period of the digital I signal;
a Q signal delaying means that delays a digital Q signal by a sampling period of the digital Q signal;
an I signal real part multiplying means that multiplies an output from said I signal delaying means by a predetermined real part coefficient, and outputs a multiplied result;
an I signal imaginary part multiplying means that multiplies the output from said I signal delaying means by a predetermined imaginary part coefficient, and outputs a multiplied result;
a Q signal real part multiplying means that multiplies an output from said Q signal delaying means by the predetermined real part coefficient, and outputs a multiplied result;
a Q signal imaginary part multiplying means that multiplies the output from said Q signal delaying means by the predetermined imaginary part coefficient, and outputs a multiplied result;
an I′ signal summing means that subtracts a summation of the outputs supplied from said Q signal imaginary part multiplying means from a summation of the outputs supplied from said I signal real part multiplying means; and
a Q′ signal summing means that adds a summation of the outputs supplied from said I signal imaginary part multiplying means to a summation of the outputs supplied from said Q signal real part multiplying means,
wherein:
the predetermined real part coefficient is an output from said real part accumulating means of said filter coefficient generating device according to claim 1; and
the predetermined imaginary part coefficient is an output from said imaginary part accumulating means of said filter coefficient generating device according to claim 1.

6. A multipath simulator comprising:
said filter coefficient generating device according to claim 1;
said filter according to claim 5;
an I′ signal D/A converter that converts the output from said I′ signal summing means of said filter into an analog I′ signal at the sampling frequency;
a Q′ signal D/A converter that converts the output from said Q′ signal summing means of said filter into an analog Q′ signal at the sampling frequency;
an I′ signal multiplier that multiplies the analog I′ signal by an RF signal with the RF modulation angular frequency;
a Q′ signal multiplier that multiplies the analog Q′ signal by an orthogonal RF signal with the same frequency as the RF signal and orthogonal in phase to the RF signal; and
an adder that adds an output from said I′ signal multiplier to an output from said Q′ signal multiplier.

7. A multipath simulator comprising:
a signal converting means that converts a digital I signal and a digital Q signal into a digital I′ signal and a digital Q′ signal based upon path delay periods and path ratios of respective paths, a sampling frequency of the digital I signal and the digital Q signal, and an RF modulation angular frequency used to modulate the digital I signal and the digital Q signal;
an I′ signal D/A converter that converts the digital I′ signal into an analog I′ signal at the sampling frequency;
a Q′ signal D/A converter that converts the digital Q′ signal into an analog Q′ signal at the sampling frequency;
an I′ signal multiplier that multiplies the analog I′ signal by an RF signal with the RF modulation angular frequency;
a Q′ signal multiplier that multiplies the analog Q′ signal by an orthogonal RF signal with the same frequency as the RF signal and orthogonal in phase to the RF signal; and
an adder that adds an output from said I′ signal multiplier to an output from said Q′ signal multiplier.

8. A filter coefficient generating method comprising:
an impulse response generating step of, based upon path delay periods of respective paths and a sampling frequency of a digital I signal and a digital Q signal, generating a discrete impulse response based upon the sampling frequency for a digital filter realizing the path delay periods, said impulse response generating step being performed by an impulse response generating means;
a path ratio multiplying step, performed by a path ratio multiplying means, of multiplying the impulse response by a path ratio;
a phase rotating step, performed by a phase rotating means, of reversely rotating a phase of an output from said path ratio multiplying step by (RF modulation angular frequency)×(path delay period);
a real part accumulating step, performed by a real part accumulating means, of accumulating a real part of an output from said phase rotating step; and
an imaginary part accumulating step, performed by an imaginary part accumulating means, of accumulating an imaginary part of the output from said phase rotating step,
wherein:
it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).

9. A program of instructions for execution by the computer to perform a process, said process comprising:
an impulse response generating step of, based upon path delay periods of respective paths and a sampling frequency of a digital I signal and a digital Q signal, generating a discrete impulse response based upon the sampling frequency for a digital filter realizing the path delay periods;
a path ratio multiplying step of multiplying the impulse response by a path ratio;
a phase rotating step of reversely rotating a phase of an output from said path ratio multiplying step by (RF modulation angular frequency)×(path delay period);
a real part accumulating step of accumulating a real part of an output from said phase rotating step; and
an imaginary part accumulating step of accumulating an imaginary part of the output from said phase rotating step,
wherein:
it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).

10. A computer-readable medium having a program of instructions for execution by the computer to perform a process, said process comprising:
an impulse response generating step of, based upon path delay periods of respective paths and a sampling frequency of a digital I signal and a digital Q signal, generating a discrete impulse response based upon the sampling frequency for a digital filter realizing the path delay periods;
a path ratio multiplying step of multiplying the impulse response by a path ratio;
a phase rotating step of reversely rotating a phase of an output from said path ratio multiplying step by (RF modulation angular frequency)×(path delay period);
a real part accumulating step of accumulating a real part of an output from said phase rotating step; and
an imaginary part accumulating step of accumulating an imaginary part of the output from said phase rotating step,
wherein:
it is assumed that an RF modulated signal obtained by modulating the digital I signal and the digital Q signal with the RF modulation angular frequency passes the plurality of paths to determine the path delay periods respectively indicating periods required to pass the paths, and the path ratios respectively indicating (a level of a signal after having passed a path)/(a level of the signal to be input to the path).
